(19) United States
(12) Patent Application Publication
(10) Pub. No.: US 2003/0084162 A1
(43) Pub. Date: May 1, 2003

(54) Managing peer-to-peer access to a device behind a firewall

(76) Inventors: Bruce L. Johnson, Eagle, ID (US); Bradley J. Anderson, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/999,707

(22) Filed: Oct. 31, 2001

(51) Int. Cl. G06F 15/16; G06F 12/14; G06F 11/30; H04L 9/32; H04L 9/00

(52) U.S. Cl. 709/227; 713/201; 709/245

(57) ABSTRACT

The described arrangements and procedures provide for peer-to-peer communications with a device that is protected by a firewall. To accomplish this, a receiving device receives a communication from the firewall protected device. The communication includes device access information necessary to communicate with the firewall protected device. The receiving device determines whether the device access information identifies a valid communication pathway to the firewall protected device. The receiving device receives a request from a different device for the information needed to communicate with the firewall protected device. Responsive to receiving the request and responsive to determining that the communication pathway to the device is valid, the device access information is communicated to the different device. The different device can use the communicated device access information to initiate a peer-to-peer communication session with the firewall protected device.

### TECHNICAL FIELD

The described subject matter relates to establishing peer-to-peer communication sessions between networked computing devices.

### BACKGROUND

Many devices on the Internet are not accessible via standard Internet protocols because they are behind a Network Address Translation (NAT) gateway device such as a router to a private network (e.g., a local-area network (LAN)). NAT allows the gateway device to use a particular set of Internet protocol (IP) addresses for internal message traffic and a different set of IP addresses for external message traffic to a public network such as the Internet. To accomplish this, the NAT device maps many private addresses to a single public address and maps a particular port on the router's public interface to a specific device on the private network—this is known as port address translation.

For example, to enable an “outbound session”, wherein a source device in a private network tries to communicate with a destination device that is outside of the private network, a NAT gateway device allocates a Transmission Control Protocol (TCP) or User Datagram Protocol (UDP) source port for use during that outbound session. The gateway device then replaces the source IP address for each source packet (from a device within the private network) with the IP address of the external or Internet adapter on the gateway device, and replaces the source TCP or UDP port number of the packet with the allocated source port number.

In this manner, the gateway device dynamically maps the IP address and source port of the source device to a different IP address and source port (port/address translation). If the destination device sends a response to the NAT gateway device, the gateway device uses the port/address mapping that was created during the outbound session to restore the source's originating IP address and originating port number. The gateway device then forwards the resulting packets to the correct device in the private network. In this manner, NAT acts as a firewall by hiding internal IP addresses from the external devices.

A NAT gateway will only allow incoming traffic (also known as an “inbound session”) from an “outside device” (a device that is not behind the gateway) in certain restricted circumstances. First, the incoming message must be sent to an address/port pair mapping (a NAT device route) that was previously established in the gateway. As discussed above such an address port pair is dynamically established when an outgoing packet has already been sent (an “outbound session”) from a device behind the gateway to an outside device. Generally, the only other way to establish such an NAT device route is for an administrator to manually configure the NAT router with a static route.

Such inbound session restrictions typically cause a number of substantial problems with outside devices/computer program applications that need to initiate communication with a device to properly operate. For instance, consider that Hewlett Packard's JetSend® product provides a device-to-device, or peer-to-peer communication protocol that allows devices to intelligently negotiate information exchange without user intervention. However, the JetSend® protocol properly functions only when the two devices can address each other directly. Thus, an outside device that uses the JetSend® protocol is not typically able to initiate an information exchange negotiation session with a different device across a NAT boundary.

A conventional technique that attempts to solve this peer-to-peer communication problem across NAT boundaries is directed to conducting a gaming session. All traffic between the devices is done via a single User Datagram Protocol (UDP) port. Devices connect to a server that is not behind a NAT boundary. The server identifies both the public and private network addresses of each message sent to it. Next, the server forwards both addresses to the other devices that have connected to the server. Upon receipt of both addresses (public and private) a device initiates a peer-to-peer connection by sending a UDP packet to both public and private addresses (this is done since a source device does not know if it is behind the same NAT gateway as the destination device to which the source device is sending the UDP packet). Such outgoing message traffic causes each NAT gateway device to open up a bi-directional NAT communication pathway (device route) for the gaming traffic to pass through.

This conventional technique creates a substantial security hole in a NAT. Any device can initiate contact with a device that is behind a NAT. Moreover, this standard technique is not designed to provide persistent access to devices. Rather, a group of individuals agree to a session, coordinate it through an address server, then the server deletes the address information and the peers operate independently thereafter. The address server does not store or maintain the routing information for future use. Even if the information were stored after coordinating a session, the communication would be unreliable for a number of different reasons.

One reason for such unreliability is because an address management process in the network may dynamically change, reassign, or expire a device's address, any of which will invalidate a device's previous NAT route. This means that the next time that a device outside of the NAT boundary attempts to initiate contact with the device, the outside device may reference a completely different device, or the attempted communications may completely fail because the particular device route (network address and port mappings) may not even exist in the network gateway's NAT table.

For example, consider that a network may implement a Dynamic Host Configuration Protocol (DHCP) server to assign IP addresses to devices (“DHCP clients”) in the network. Unless an assigned network address is permanently assigned (a “reservation”) to a specific network device, the DHCP server places an administrator-defined time limit on the assignment, called a lease. The lease is the length of time that a DHCP server specifies that a client device can use the assigned IP address. A DHCP client must periodically request a lease renewal, for the DHCP server to extend the network address lease.

There are any number of reasons why a DHCP client may not request lease renewal such as if the client device is malfunctioning, if it has been moved to another network segment, if the device has been retired, and so on. If the client device does not request renewal of the lease, it expires—meaning that the network address can no longer be used by a device outside of the firewall to initiate in inbound communication session with the protected resource. Upon lease expiration, the expired address is returned to an address pool for reassignment to a different device Thus, conventional address management techniques may invalidate a NAT device route (regardless of whether the device route is static or dynamic). Conventional techniques to provide direct communication between devices behind NAT gateways do not provide for such device route invalidation.

Yet another problem with the traditional techniques to provide peer-to-peer communications between devices behind NAT boundaries is that they do not typically provide for the secure distribution of addressing information. Existing solutions address the methods to create access to a computer behind a NAT without addressing the security issues created by opening holes in the NAT firewall.

However, not all devices, applications, and protocols in such a system will necessarily be able to establish peer-to-peer communications with one another because not all applications and application protocols are compatible with one another. For example, a device that implements the JetSend® protocol may only interoperate with another device that implements the same or other aspects of the protocol.

Thus, even though conventional systems and techniques provide for the establishment of peer-to-peer communications through NAT boundaries, such conventional systems and techniques are problematic in that they do not typically provide reliable peer-to-peer communication pathways. Moreover such conventional systems and procedures do not generally provide a way for a user to identify a particular device with which to establish peer-to-peer communications.

Accordingly, the various implementations of the following described subject matter address these and other problems of conventional techniques to provide access to devices that are behind a firewall boundary.

### SUMMARY

The described arrangements and procedures provide for peer-to-peer communications with a device that is protected by a firewall. To accomplish this, a receiving device receives a communication from the firewall protected device. The communication includes device access information necessary to communicate with the firewall protected device. The receiving device determines whether the device access information identifies a valid communication pathway to the firewall protected device. The receiving device receives a request from a different device for the information needed to communicate with the firewall protected device. Responsive to receiving the request and responsive to determining that the communication pathway to the device is valid, the device access information is communicated to the different device. The different device can use the communicated device access information to initiate a peer-to-peer communication session with the firewall protected device.

### BRIEF DESCRIPTION OF THE DRAWINGS

The same numbers are used throughout the drawings to reference like features and components.

FIG. 1 shows aspects of an exemplary datagram packet that is periodically communicated by a device that is behind a NAT firewall to another device that is not behind the NAT firewall.

FIG. 2 shows aspects of an exemplary device access-mapping table to identify information that can be used by a first device that is not behind a NAT gateway device to initiate communications with a second device that is behind the NAT gateway.

FIG. 3 shows aspects of an exemplary system to provide peer-to-peer access to a device that is behind a firewall.

FIG. 4 shows aspects of an exemplary procedure to generate and maintain a table of communication pathways to devices that are behind a firewall.

FIG. 5 shows further aspects of an exemplary procedure to generate and maintain a table of communication pathways to devices that are behind a firewall. In particular procedure also invalidates device routes that have expired or otherwise have been nullified from a device access-mapping table.

FIG. 6 shows further aspects of an exemplary procedure to manage and maintain a table of communication pathways to one or more devices that are behind a firewall. In particular, the procedure also communicates a global address list to a first device that is not behind the firewall, thereby enabling the first device to selectively initiate a peer-to-peer connection with a particular second device that is behind the firewall.

### DETAILED DESCRIPTION

Overview

The described arrangements and procedures provide for a first device that is not behind a particular NAT gateway to initiate and establish peer-to-peer communications with a second device that is behind the particular NAT gateway. Although the first device is not behind the particular NAT gateway, the first device may or may not be located behind a different firewall such as a different NAT gateway. The communication pathway(s) across the firewall boundary to the second device is periodically evaluated to determine if it is a valid communication pathway to the second device. The pathway is invalidated for a number of different reasons (e.g., if the second device malfunctions, if the second device is removed from the network, if the second device's network address expires and/or is reassigned to different device that is behind the NAT gateway, etc.).

Additionally, the described subject matter establishes and maintains a global address list of private devices that are behind NAT gateways, thereby allowing a device that is not behind the particular NAT gateway to select a particular private device of the private devices with which to initiate and establish peer-to-peer communications. The protocol clients coordinate access with the address server so that only peers authenticated through the address server may connect to devices that incorporate this invention.

Exemplary Data Structures

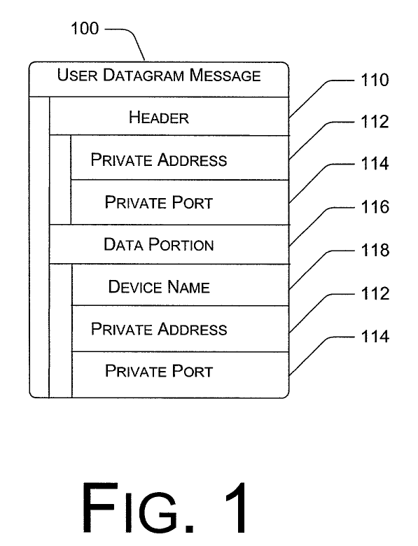

FIG. 1 shows exemplary datagram packet 100 that is periodically communicated by a device that is behind a NAT firewall to another device that is not behind the NAT firewall. (Hereinafter, a device that is behind a firewall is often referred to as a “private” or “protected” device). Each datagram packet (or “message”) includes a header portion 110 and a data portion 116. The header includes a private address 112 and a private port number 114. The private address is the device's actual configured address, and the private port is a port that is allocated by the device for use during input/output (I/O) with a device that is not in the same network as the source device.

The data portion 116 includes a device name 118, and a copy of the device's private address 112 and private port number 114. The device name is a name such as an alias name, the device's serial no., LAN ID, and so on, that uniquely identifies the device 308 that is sending the datagram packet (the “source device”) to the address server 312.

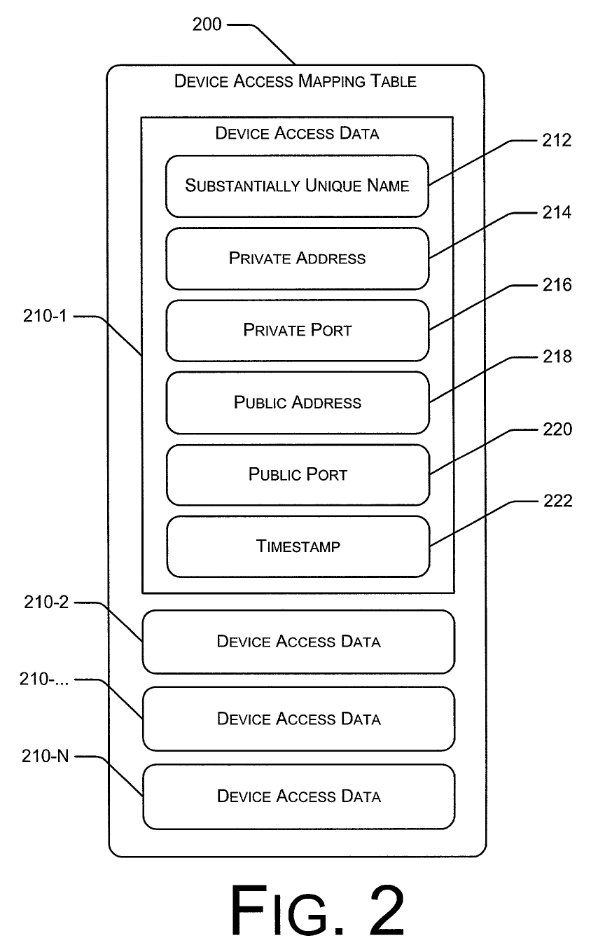

A NAT gateway such as a router rewrites the header portion 110 of an outbound datagram 100 during the gateway's address translation procedures. This means that the sending device's private address 110 and private port 112 are overwritten with the gateway's public address and port. However, the data portion of the datagram is not re-written by the gateway device. Thus, the source device's actual configured private address, private port number, and name are available for use by another device. (Aspects of an exemplary system and procedure to use datagram messages to create a device access-mapping table 200 of FIG. 2, and to validate communication pathways are described in greater detail below respectively in reference to FIGS. 1 and 4-6).

FIG. 2 shows an exemplary device access-mapping table 200 to store information that can be used by a first device that is not behind a NAT gateway device to initiate communications with a second device that is behind the NAT gateway. The device-access mapping table 200 includes one or more blocks of device access data 210. Each block of data 210 includes data such as a substantially unique name 212 (see, the device name 110 of FIG. 1), a private network address 214, a private port no. 316, a public network address 218, a public port no. 220, and a time stamp 322.

As discussed above in reference to the device name 118 of FIG. 1, the device name 212 is a name such as an alias name, a the device's serial no., LAN ID, and so on, that uniquely identifies a particular device that sent a datagram 100 of FIG. 1 to a device that is not behind a same NAT gateway as the particular device. In one implementation, the substantially unique name is the name provided by datagram message 100 of FIG. 1.

The private address 214 is a network address of a particular device that is behind a NAT gateway—the private address is the device's actual configured address. The private port 216 is a port that was allocated by the particular device for use during input/output (I/O) with a device that is not behind the same NAT gateway as the particular device. The public address 218 and public port 220 correspond to the address and port supplied by a gateway device during its address translation procedures in response to an outbound message. (A device that is not behind the NAT gateway must use the public network address and the public port to initiate a peer-to-peer communication session with the particular device).

The time-stamp data field 222 is used by a first device that is not behind a particular NAT gateway to indicate a time when a datagram message 100 of FIG. 1 from a second device that is behind the particular NAT gateway.

Aspects of an exemplary system and procedure to use the data provided by the access-mapping table 200 to initiate communications with a device that is behind a NAT gateway, and to validate a NAT device route to the device are described in greater detail below in reference to FIGS. 1 and 4-6.

An Exemplary System

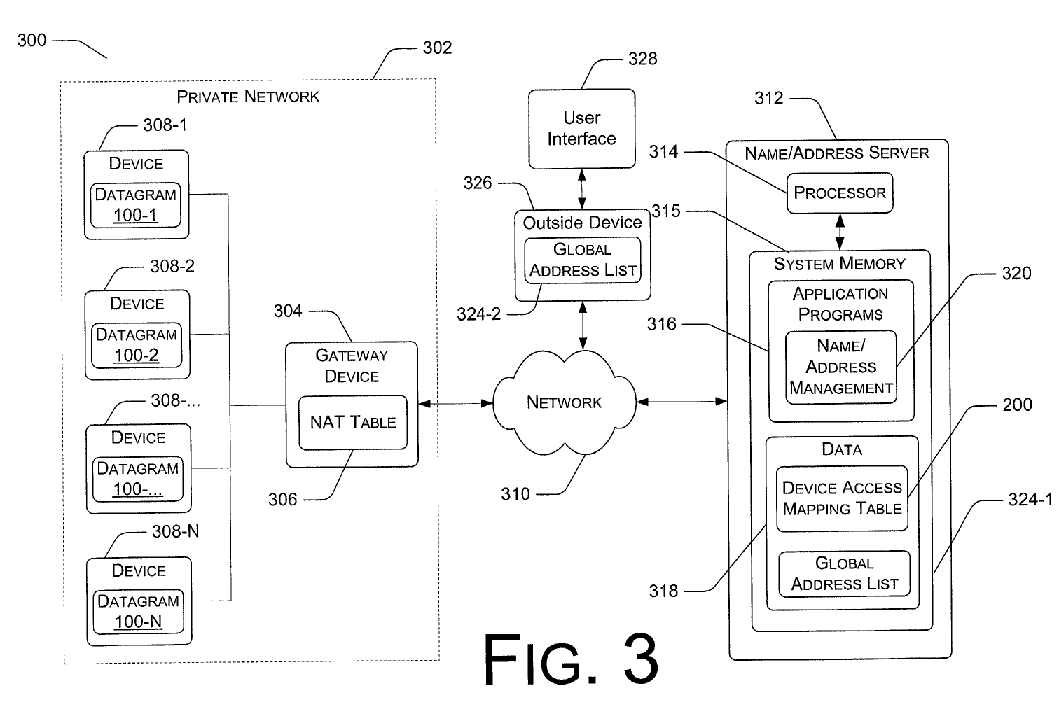

FIG. 3 shows aspects of an exemplary system 300 to provide peer-to-peer access to devices that are behind a firewall. The exemplary system is only an example of a suitable computing environment to implement the described inventive subject matter and does not suggest any limitation as to the scope of the subject matter. The system includes a private network 302 such as a Local Area Network (LAN), an organizational intranet, and so on. The private network is coupled across a different network 310 to a name/address server 312. The other network 310 can be any type of network such as another private network and/or a public network such as the Internet. Both the private network and the name/address server are operatively coupled across the other network 310 to one or more other devices 326.

The private network 302 includes a number of devices 308 such as one or more personal computers, server devices, printers, and/or other computing and peripheral devices. Each device is operatively coupled to a gateway device 304 such as a network router, a DSL modem, a cable modem, or the like. The gateway device acts as a firewall because it implements NAT, and thereby uses a particular set of IP addresses for message traffic that is internal to the private network 302, and uses a different set of IP addresses for external message traffic across the other network 310. The gateway device may also implement the dynamic network address configuration protocol (e.g., DHCP) to dynamically assign, expire, or re-assign network addresses to the devices 308.

The name/address server 312 provides the “outside device” 326 with the ability to initiate and establish peer-to-peer communications with a device 308 that is behind the firewall 304. An “outside device” is a device that is not in the private network 302. (The outside device may or may not be located behind a different firewall such as a different NAT gateway device, or the like). The name/server manages access to the peer-to-peer communication pathways to substantially ensure that any device routes to a device 308 that are provided by the name/address server are valid, regardless of whether network addresses behind the firewall 304 are dynamically assigned to network devices 308, expired and placed into a pool of unused addresses, or reassigned to different devices 308.

Moreover the name/address server 312 provides for the establishment of a global address list 324 of devices 308 that are behind a NAT gateway device 304, thereby allowing an outside device 326 to select a particular device 308 in the private network 302 which to initiate and establish peer-to-peer communications.

To accomplish this, the name/address server includes a processor 314 that is coupled to a system memory 315. The system memory includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, and so on.

The processor 314 is configured to fetch and execute computer program instructions from application programs 316 such as an operating system, a name/address management module 320, and the like. The processor is also configured to fetch data 318 such as a device access-mapping table 200 of FIG. 1), a global address list 324, etc., while executing the application programs.

When a private device 308 (e.g., a printer, a JetSend® enabled digital sender, etc.) is installed behind the NAT gateway device 304, the private device communicates an initial datagram message 100 of FIG. 1 to the address server 312. The private device determines the network address of the address server 312 in a number of different ways. For instance: (a) the private device can be configured with the address server's network address upon installation in the private network 302; (b) the name of the address server may be known and conventional DNS lookups can be used to acquire the IP address; and/or (c) the address server may be configured via BOOTP parameters or additional DHCP parameters when the device is auto-configured on the network.

By communicating a datagram message 100 of FIG. 1 to the address server 312, the private device 308 causes a dynamic NAT device route to be created in the NAT table 308. This is because the address server is outside of the private network 302. (Procedures to create a dynamic NAT device route have already been described above). To keep the dynamic device route open/active, the private device continues to periodically generate and communicate a datagram message to the address server.

Responsive to receiving an initial datagram 100 of FIG. 1 from a private device 308, the name/address server 312 creates a corresponding entry 210 into the access-mapping table 200 of FIG. 2. The server stores a time indication into the timestamp data field 318 to indicate the specific time that the datagram was received by the server. The server also copies and stores the information indicated by the header 110 and data portions 116 of the datagram into corresponding data fields of the created entry. As discussed in greater detail above in reference to FIG. 2, this information includes a substantially unique name 212, a private network address 214 (see, the private address 112 of FIG. 1), a private port no. 316 (see, the private port 114 of FIG. 1), a public network address 218, and a public port 220.

After a private device 308 sends an initial datagram message 100 of FIG. 1 to the server 312, the private device periodically re-transmits the datagram to the server to keep the dynamic device route to the private device open/active. (The dynamic device route was created by the NAT gateway 304 in response to the transmission of the initial datagram to the server). (A NAT gateway may expire a device route after a predetermined amount of time has elapsed since the route has seen any activity). Responsive to receiving a datagram from the private device, the device's corresponding timestamp element 222 of FIG. 2 is updated to indicate the time that the datagram was received.

The address server 312 determines if the server's stored access information 200 to a private device 308 is valid in a number of different ways. In one implementation, because a private device communicates a datagram message 100 of FIG. 1 to the server 312 at periodic first predetermined time intervals, the server uses the timestamp 222 of FIG. 2 to determine whether or not a next datagram is received from the device before expiration of a second predetermined time interval since the previous datagram from the device was received. A device may stop sending datagrams if it malfunctions, is moved to a different route on the network, its time lease on its private network address expires or is reassigned to a different device, etc.

If a device 308 does not communicate a subsequent datagram 100 of FIG. 1 to the server 312 before expiration of the second predetermined time period, the server indicates that the device's corresponding communication pathway information is not valid. The server can be accomplish this by flagging the device's corresponding entry 210 in the mapping table 200 of FIGS. 2 and 3 as invalid, or by removing the entry from the table.

If the server 312 receives a next datagram 100 of FIG. 1 from a private device 308 before expiration of the second predetermined time interval since a previous datagram from the source device was received, the server evaluates the information in the newly received datagram (as indicated by the datagram's indicated unique device name 118, private address 112 and private port 114) as compared to a corresponding data fields in the mapping table 200 if FIG. 2. If the mapping table's private address 214 matches the datagram's private address 112, the mapping table's unique name 212 and private port number 316 are respectively compared to the datagram's device name 118 and private port number 114 indications. The server invalidates the corresponding communication path entry 210 in the mapping table if any of these data fields do not match. Otherwise, the pathway is determined to be a valid communication pathway.

In one implementation, the name/address server 312 sets the second predetermined time interval to a value that provides an additional amount of time (a time “buffer”) over the first predetermined amount of time to allow for any processing delays that may be experienced by a private device 308 (e.g., so that a device 308 can complete a print job, or the like) and/or to allow for any network congestion that a packet from the private device may experience while being communicated to the address server 312.

In yet another implementation, the address server 312 determines if a private device's 308 access information (as stored in the device access-mapping table 200 of FIGS. 2 and 3) identifies a valid communication pathway to the device by proactively forwarding a respective request message to each of the private device's represented in the mapping table. For example, an Internet Control Message Protocol (ICMP) Echo (or “Ping” message) is forwarded to a private device that has a corresponding mapping in the mapping table. (The Ping message protocol is a well-known message in the art of computer programming).

If a targeted private device 308 responds (e.g., with a datagram message 100 of FIG. 1, or some other message that includes the data portion 116 of the message) to a Ping message within the second predetermined amount of time, and if the response's data entries correspond to each of the targeted device's entries in the mapping table 200, then the communication pathway is still valid. (Aspects of an exemplary procedure to evaluate whether data fields 116 of FIG. 1 correspond to data fields in the mapping table are described in greater detail above). Otherwise, the corresponding communication path as indicated in the mapping table is determined by the server to be invalid.

Responsive to receiving a request from an outside device 326, the address server 312 communicates a predetermined portion of each device access data entry 210 of FIG. 2 in the device access-mapping table 200 to the outside device. The predetermined portion includes the public network address 218 (the public address is the gateway device's 304 network address) the public port number 320, and optionally the substantially unique name 212 of the corresponding private device 308. This predetermined portion is communicated to the outside device as the global device list 324-1 and stored by the outside device as illustrated by the global device list 324-2. The outside device uses the global address list to initiate a peer-to-peer communication session with one or more of the private devices 308 using a private device's corresponding public network address 218 and public port number 220.

If the address server 312 communicates a private device's 308 substantially unique name 212 of FIG. 2 along with the device's corresponding public address 218 and private port 220 to the outside device 326, the outside device can display the private device's 308 unique name on a user interface 328 such as a CRT, an LED, and so on, for a user to select. In this manner, a user-friendly name can be used to identify a particular private device 308 with which to initiate a peer-to-peer communication session.

Moreover, if the server 312 communicates a private device's 308 corresponding entry 210 from the device access-mapping table of FIG. 2 to the private device, the private device can in turn distribute this information to an outside device 326. The outside device can use this distributed information to initiate a peer-to-peer communication with the private device without going through the server.

For instance, consider that the private device 308 is a printer, the printer stores the server 312 distributed information 324 in a memory and subsequently prints the information on a test/configuration page for a user to view and subsequently distribute at will. The printer may also automatically communicate the received information to other devices. An outside device 326, upon receiving this information, displays a list of substantially unique device names 312. A user of the outside device, using an input device such as a keyboard, a mouse, and so on, may select a particular device 308 from the displayed device names to indicate the particular private device 308 with which to initiate a peer-to-peer communication session over the firewall 304 boundary.

An outside device 326 can also register its corresponding services (e.g., printing services, digital sender services, and so on) with the address server 312. To accomplish this, the outside device communicates a datagram packet 100 of FIG. 1 to the server. If the packet's private address 112 and the public address match, then the server knows that the outside device is not behind a NAT gateway device. (A NAT gateway device would have replaced the device's private address with a public address assigned by the gateway). Thus, the server knows not to expect periodic datagrams from the outside device since they are not necessary to keep open any dynamic NAT device route. Rather, the server verifies the device and its communication pathway by periodically sending the outside device a request message such as a Ping message as described in greater detail above. In this manner the server maintains communication pathway information to any number of outside devices as well as communication pathway information to any number of private devices 308 in the device access-mapping table 200 of FIG. 2.

The security of the private network 300 is enhanced by only allowing authorized devices 326 to communicate messages to a private device 308 behind a NAT. All messages between a private device, an address server, and an outside device are encrypted. (There are a number of different message encrypting technologies such as Pretty Good Privacy (PGP), etc.) A device 308 connects to the server 332 and downloads a public key. The private device 308 uses this key to encrypt the address information in the UDP packet (e.g., packet 100 of FIG. 1) that is sent to the address server along with the private device's own public key. Now, both the device 308 and the address server have public keys for encryption of data that is communicated between them.

The address sever 332 acts as a security broker between the private device 308 and any outside device's 326 that want to communicate with the private device. An administrator of the private device configures a use policy on the device (e.g., using a Web browser, Hewlett Packard's Web JetAdmin®, and so on). Upon connecting to the address server, the private device supplies the use policy to the address server. The address server only provides the private device's address and public key to those outside devices that conform to the use policy.

When an outside/client device 326 wishes to make a peer-to-peer connection to a private device 308 that is behind a NAT, the client requests the address information for the private device from the address server 332. If authorized by the private device's use policy, the address server signs the packet with its private encryption key, and returns it to the client that wishes to initiate the connection. When the private device receives the encrypted request for connection from the client device, the private device uses the address server's public key to confirm that the requesting device is an authorized device.

This technique is advantageous in that it maintains the privacy of the private network 302 as well as the privacy of the device's encryption key between the address server and the private device.

Computer-Executable Instructions

The subject matter is illustrated in the drawings as being implemented in a suitable computing environment. Although not required, the subject matter is described in the general context of computer-executable instructions, such as a program module 320 that is executed by a computing device such as the name/address server 312. Program modules typically include routines, programs, objects, components, data structures, and the like, that perform particular tasks or implement particular abstract data types. Moreover, those skilled in the art will appreciate that the invention may be practiced with other computer system configurations, including multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices (computer-readable media).

An Exemplary Procedure

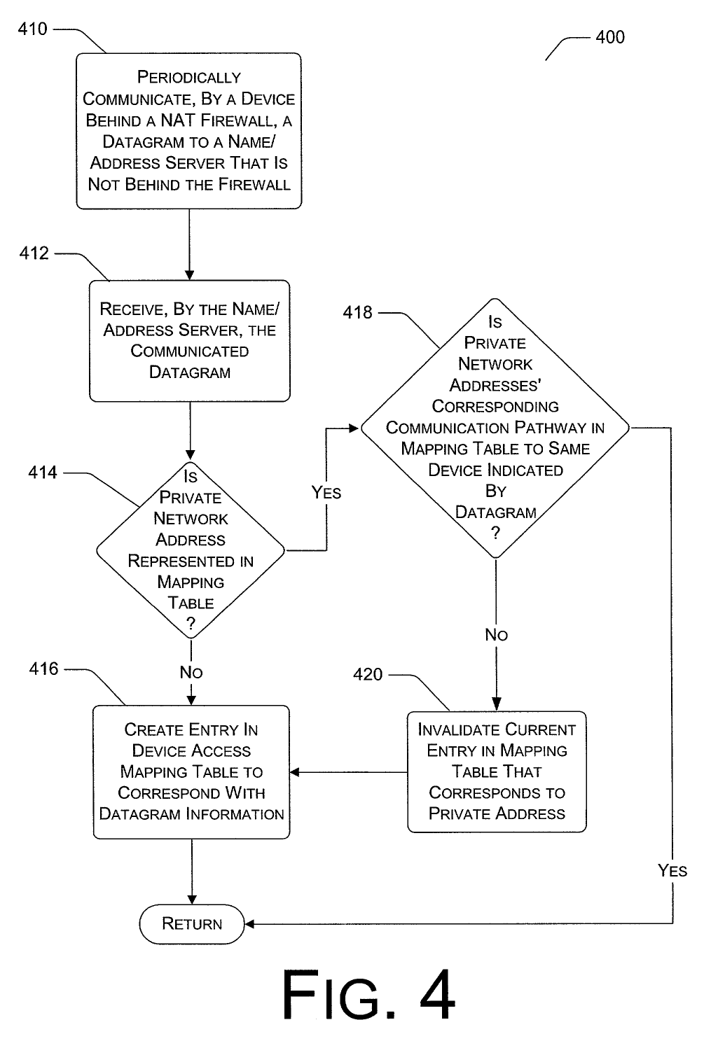

FIG. 4 shows an exemplary procedure 400 to generate and maintain a table of communication pathways to devices that are behind a firewall. At block 410, a private device that is behind a firewall such as a NAT Gateway, periodically communicates a datagram (see, datagram 100 of FIG. 1) to a name/address server (see, server 312 of FIG. 3) that is not behind the firewall. At block 412, the name/address server receives the communicated datagram message. At block 414, the name/address server determines whether the private network address represented in the datagram message is represented in the device access-mapping table (see mapping table 200 of FIGS. 2 and 3).

At block 416, responsive to determining that the private network address represented in the datagram message is not represented in the device access mapping table (block 414), the name/address server creates an entry in the mapping table to correspond with the datagram information. Such an entry includes a substantially unique name for the private device that communicated the datagram (block 410), the private device's private address, the private device's private port, a public address of the NAT Gateway device, and a public port of the Gateway device. The name/address server also indicates a time that the datagram was received by storing a timestamp (see, timestamp 222 of FIG. 2) into the mapping table. (See, name 212, private address 214, private port 216, public address 218, and public port 220 of FIG. 2).

At block 418, responsive to determining that the private network address represented in the datagram message is represented in the device access mapping table (block 414), the procedure determines whether the private network addresses' corresponding communication pathway in the device access-mapping table identifies the same device that is identified by the received datagram (block 412). On reason for this determination is because network addresses are often dynamically assigned, reassigned, and expired.

Specifically, the procedure 400 determines if the datagram's device name and the private port indications (see block 412, device name 118 and private port 114 of FIG. 1) correspond to the mapping table's substantially unique name 212 and private port 216. If they do not correspond: (a) at block 420, the procedure invalidates the current corresponding mapping table entry—the one that corresponds to the private address indicated by the received datagram (block 412); and (b) at block 416, the procedure creates a new entry (see, device access entries 210 of FIG. 2) in the mapping table that corresponds to the information included with the datagram.

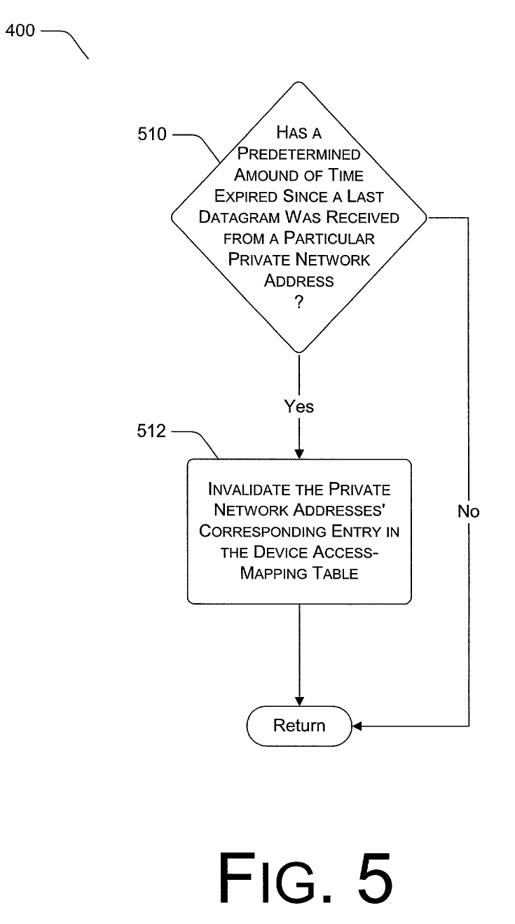

FIG. 5 shows further aspects of an exemplary procedure 400 to generate and maintain a table of communication pathways to devices that are behind a firewall. In particular the procedure invalidates device routes from a device access-mapping table that have expired. To accomplish this, at block 510, the procedure determines whether or not a predetermined amount of time has expired since a last datagram (see, datagram 100 of FIG. 1) was received from a particular private network address that is represented by a corresponding entry in the device access-mapping table. (See, the device-access mapping table 200 of FIG. 2). At block 512, the procedure invalidates the corresponding entry in the mapping table (it having been determined that the predetermined amount of time has expired since a last datagram was received from the particular network address).

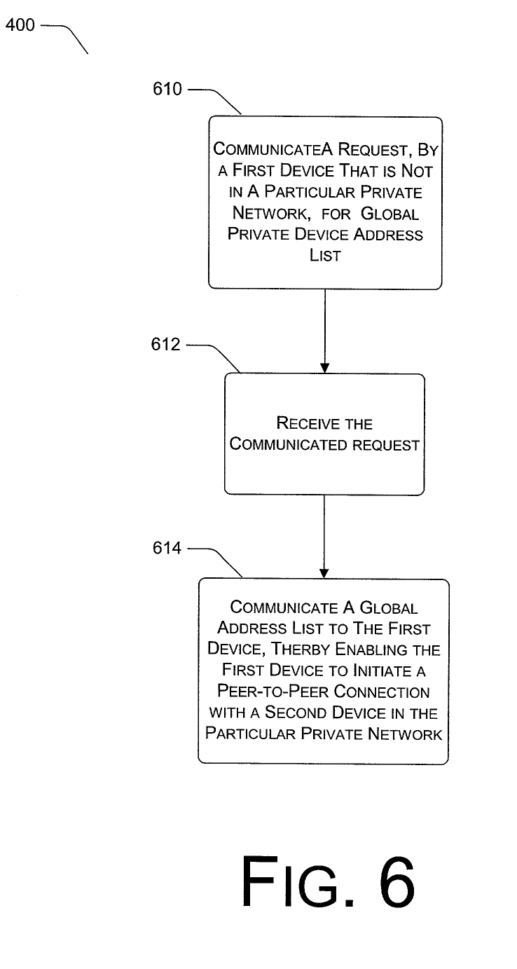

FIG. 6 shows further aspects of an exemplary procedure 400 to manage and maintain a table of communication pathways to one or more devices that are behind a firewall. In particular, the procedure also communicates a global address list to a first device that is not behind the firewall, thereby enabling the first device to selectively initiate a peer-to-peer connection with a particular second device that is behind the firewall.

At block 610, the procedure communicates a request, by a first device that is not in a particular private network, for a global private device address list. At block 612, the procedure receives the communicated request (block 610). At block 614, responsive to receiving the communicated request (block 612), the procedure communicates a global address list to the first device, thereby enabling the first device to initiate a peer-to-peer connection with a different device across a firewall boundary.

### CONCLUSION

Although the subject matter has been described in language specific to structural features and/or methodological operations, it is to be understood that the subject matter defined in the appended claims is not necessarily limited to the specific features or operations described. Rather, the specific features and steps are disclosed as preferred forms of implementing the claimed subject matter.

1. A method comprising:
receiving a communication from a device that is behind a firewall, the communication comprising a set of device access information to communicate with the device;
determining whether or not the device access information identifies a valid communication pathway to the device;
receiving, from a different device, a request for the device access information; and
responsive to receiving the request and responsive to determining that the communication pathway to the device is valid, communicating at least one subset of the device access information to the different device such that the different device can initiate a peer-to-peer communication session with the device.

2. A method as recited in claim 1, wherein the different device is not behind a firewall.

3. A method as recited in claim 1, wherein the firewall is a first firewall, and wherein the different device is behind a second firewall that is not the first firewall.

4. A method as recited in claim 1, wherein the different device is an authorized device.

5. A method as recited in claim 1, wherein the device access information comprises a public network address, a public port number, a private network address, a private port number, and a substantially unique device name.

6. A method as recited in claim 1, wherein determining whether or not the device access information identifies a communication pathway to the device is valid further comprises determining at predetermined periodic time intervals whether or not the device access information identifies a communication pathway to the device that is valid.

7. A method as recited in claim 1, wherein the method further comprises:
responsive to receiving the communication, generating a table to identify the device access information; and
wherein communicating the device access information to the different device further comprises communicating the table or a reference to the table to the different device.

8. A method as recited in claim 1, wherein receiving the communication from the device, the communication is received at predetermined periodic time intervals, and wherein determining whether or not the device access information identifies a valid communication pathway to the device further comprises:
responsive to determining that the communication from the device was received before expiration of the predetermined periodic time interval since a last communication from the device was received, indicating that the device access information identifies a valid communication pathway; and
responsive to determining that the communication from the device was not received before expiration of the predetermined periodic time interval since a last communication from the device was received, indicating that the device access information does not identify a valid communication pathway.

9. A method as recited in claim 1, wherein determining whether or not the device access information identifies a valid communication pathway to the device further comprises:
forwarding a request message to the device, the request message requiring a response from the device;
receiving the response from the device; and
responsive to the receiving, validating the communication pathway.

10. A method as recited in claim 1, wherein determining whether or not the device access information identifies a valid communication pathway to the device further comprises:
forwarding a request message to the device, the request message requiring a response from the device;
determining that the response will not be forwarded from the device; and
responsive to the determining that the response will not be forwarded, invalidating the communication pathway.

11. A method as recited in claim 1:
wherein the device access information comprises a private network address and public information comprising a public network address and a public port; and
wherein communicating the device access information to the different device further comprises:
assigning a unique ID to the device, the unique ID being independent of the private address and the public information; and
communicating the public information and the unique ID to the different device.

12. An address server comprising:
a memory comprising a plurality of computer program modules and data, the computer program modules comprising computer-executable instructions; and
a processor operatively coupled to the memory, the processor being configured to fetch and execute the computer-executable instructions, the computer-executable instructions comprising instructions for:
receiving a communication from a device that is behind a firewall, the communication comprising a set of information to communicate with the device;
determining whether or not the information identifies a valid communication pathway to the device;
receiving, from a different device, a request for the information; and
responsive to receiving the request, if the information identifies a valid communication pathway, communicating the information to the different device such that the different device can establish peer-to-peer communication to the device.

13. An address server as recited in claim 12, wherein the different device is an authorized device.

14. An address server as recited in claim 12, wherein the information comprises a public network address, a public port number, a private network address, a private port number, and a substantially unique device name.

15. An address server as recited in claim 12, wherein the computer-executable instructions for determining whether or not the information identifies a valid communication pathway to the device further comprise instructions for determining at predetermined periodic time intervals whether or not the information identifies a valid communication pathway to the device.

16. An address server as recited in claim 12, further comprising computer-executable instructions for:
responsive to receiving the communication, generating a table to identify the information; and
wherein the instructions for communicating the information to the different device further comprise instructions for communicating the table or a reference to the table to the different device.

17. An address server as recited in claim 12:
wherein the communication is received at predetermined periodic time intervals; and
wherein the instructions for determining whether or not the information identifies a valid communication pathway further comprise instructions for:
responsive to determining that the communication from the device was received before expiration of the predetermined periodic time interval since a last communication from the device was received, indicating that the information identifies a valid communication pathway; and
responsive to determining that the communication from the device was not received before expiration of the predetermined periodic time interval since a last communication from the device was received, indicating that the information does not identify a valid communication pathway.

18. An address server as recited in claim 12, wherein the computer-executable instructions for determining whether or not the information identifies a valid communication pathway to the device further comprise instructions for:
forwarding a request message to the device, the request message requiring a response from the device; and
receiving the response from the device; and
responsive to receiving the response, validating the communication pathway.

19. An address server as recited in claim 12, wherein the computer-executable instructions for determining whether or not the information identifies a valid communication pathway to the device further comprise instructions for:
forwarding a request message to the device, the request message requiring a response from the device; and
determining that the response will not be forwarded from the device; and
responsive to the determining, invalidating the communication pathway.

20. An address server as recited in claim 12, wherein the information comprises a private network address and public information, the public information comprising a public network address and a public port, and wherein the instructions for communicating the information to the different device further comprise instructions for:
assigning a unique ID to the device, the unique ID being independent of the private address and the public information; and
communicating the public information and the unique ID to the different device.

21. A system comprising:
a first device that is behind a firewall in a private network, the first device being operatively coupled to an address server and a second device that is not in the private network, the first device being configured to periodically communicate a datagram message to the address server, the datagram message comprising device access information to communicate with the device,
the address server being configured to store the device access information into a mapping table in response to receiving the datagram message, the address server being further configured to communicate at least one subset of the mapping table to a second device in response to receiving a request from the second device, the at least one subset of the mapping table enabling the second device to initiate a peer-to-peer communication session with the first device.

22. A system as recited in claim 21, wherein the different device is an authorized device.

23. A system as recited in claim 21, wherein the device access information comprises a public network address, a public port number, a private network address, a private port number, and a substantially unique device name.

24. A system as recited in claim 21, wherein the address server is further configured to determine, at predetermined periodic time intervals, whether or not the device access information that is stored in the device access-mapping table identifies a valid communication pathway to a particular device.

25. A system as recited in claim 21, wherein the address server is further configured to determine whether or not a particular device's information that is stored in the device access-mapping table identifies a valid communication pathway to the particular device by:
forwarding a request message to the particular device, the request message requiring a response from the particular device;
receiving the response from the particular device; and
responsive to receiving the response, validating the communication pathway.

26. A system as recited in claim 21, wherein the address server is further configured to determine whether or not a particular device's information that is stored in the device access-mapping table identifies a valid communication pathway to the particular device by:
forwarding a request message to the particular device, the request message requiring a response from the particular device;
determining that the response will not be forwarded from the particular device; and
responsive to determining that the response will not be forwarded, invalidating the particular device's information in the device access-mapping table.

27. Computer readable media comprising computer executable instructions for:
receiving a communication from a protected device that is behind a firewall, the communication comprising information to communicate with the protected device;
determining whether or not the information identifies a valid communication pathway to the protected device;
receiving, from a different device that is not behind the firewall, a request for information; and
responsive to receiving the request, if the information identifies a valid communication pathway, communicating the information to the different device such that the different device can establish peer-to-peer communication to the protected device.

28. Computer-readable media as recited in claim 27, wherein the different device is an authorized device.

29. Computer-readable media as recited in claim 27, wherein the information comprises a public network address, a public port number, a private network address, a private port number, and a substantially unique device name.

30. Computer-readable media as recited in claim 27, wherein the computer-executable instructions for determining whether or not the information identifies a valid communication pathway to the protected device further comprises instructions for determining at predetermined periodic time intervals whether or not the information identifies a valid communication pathway to the protected device.

31. Computer-readable media as recited in claim 27, further comprising the computer-executable instructions for:
responsive to receiving the communication, generating a table to identify the information; and
wherein communicating the information to the different device further comprises communicating the table or a reference to the table to the different device.

32. Computer-readable media as recited in claim 27, wherein the communication is received at predetermined periodic time intervals, and wherein the instructions for determining whether or not the information identifies a valid communication pathway to the protected device further comprise instructions for:
responsive to determining that the communication from the protected device was received before expiration of the predetermined periodic time interval since a last communication from the protected device was received, indicating that the information identifies a valid communication pathway; and
responsive to determining that the communication from the protected device was not received before expiration of the predetermined periodic time interval since a last communication from the protected device was received, indicating that the information does not identify a valid communication pathway.

33. Computer-readable media as recited in claim 27, wherein the computer-executable instructions for determining whether or not the information identifies a valid communication pathway to the protected device further comprise instructions for:
forwarding a request message to the protected device, the request message requiring a response from the protected device;
receiving the response from the protected device; and
responsive to receiving the response, validating the communication pathway.

34. An Computer-readable media as recited in claim 27, wherein the computer-executable instructions for determining whether or not the information identifies a valid communication pathway to the protected device further comprise instructions for:
forwarding a request message to the protected device, the request message requiring a response from the protected device;
determining that the response will not be forwarded from the protected device; and
responsive to determining that the response will not be forwarded, invalidating the communication pathway.

35. Computer-readable media as recited in claim 27, wherein the information comprises a private network address and a set of public information, the public information comprising a public network address and a public port, and wherein the instructions for communicating the information to the different device further comprise instructions for:
assigning a unique ID to the protected device, the unique ID being independent of the private address and the public information; and
communicating the public information and the unique ID to the different device.
